(19) United States
(12) Patent Application Publication
(10) Pub. No.: US 2025/0370112 A1
(43) Pub. Date: Dec. 4, 2025

(54) METHOD AND CONTROL DEVICE FOR CONTROLLING AN ENVIRONMENT CAPTURING SENSOR SYSTEM

(71) Applicant: ZF FRIEDRICHSHAFEN AG, Friedrichshafen (DE)

(72) Inventors: Matthias RÜBER, Oberteuringen (DE); Andreas WALTER, Bad Saulgau (DE); Peter HERZOG, Baienfurt (DE)

(21) Appl. No.: 19/110,454

(22) PCT Filed: Aug. 7, 2023
(86) PCT No.: PCT/EP2023/071756

§ 371 Date: Mar. 11, 2025

(30) Foreign Application Priority Data
Sep. 12, 2022 (DE) 10 2022 209 479.4

(51) Int. Cl. G01S 7/497; G01S 7/40

(52) U.S. Cl. CPC G01S 7/4972; G01S 7/4043

(57) ABSTRACT

A method for controlling an environment capturing sensor system which is arranged on a vehicle, including reading a control signal for controlling a vehicle component of the vehicle, wherein the vehicle is configured to be controlled such that the position of the vehicle component relative to the environment capturing sensor system changes. The method further includes defining a dynamic location region of the vehicle component within an outer contour of the vehicle depending on the control signal reading and defining a restricted capture region by omitting at least a sub region of the defined dynamic location region of the vehicle component from a capture region of the environment capturing sensor system. The method further includes outputting a control signal for capturing the vehicle environment in the defined restricted capture region.

### CROSS REFERENCE TO RELATED APPLICATIONS

This application is a U.S. National Phase application under 35 U.S.C. § 371 of International Application No. PCT/EP2023/071756, filed on Aug. 7, 2023, and claims benefit to German Patent Application No. DE 10 2022 209 479.4, filed on Sep. 12, 2022. The International Application was published in German on Mar. 21, 2024 as WO 2024/056280 A1 under PCT Article 21(2).

### FIELD

The present invention relates to a method and a control device for controlling an environment capturing sensor system of a vehicle and to a vehicle with such a control device.

### BACKGROUND

Objects in the vicinity of a vehicle can represent obstacles or sources of information for the operation of the vehicle. By means of an environment capturing sensor system, objects in the vicinity of a vehicle can be captured and recognized. The vehicle is controlled based on the captured and recognized objects.

From DE 10 2018 222 036 A1 it is known to adapt a capture region of an environment capturing system to a location region of an object that is in the vicinity of the vehicle. Interfering objects in the vicinity of the vehicle can thus be taken into account when capturing an environment.

### SUMMARY

In an embodiment, the present disclosure provides a method for controlling an environment capturing sensor system which is arranged on a vehicle, comprising reading a control signal for controlling a vehicle component of the vehicle, wherein the vehicle is configured to be controlled such that the position of the vehicle component relative to the environment capturing sensor system changes. The method further comprises defining a dynamic location region of the vehicle component within an outer contour of the vehicle depending on the control signal reading and defining a restricted capture region by omitting at least a sub region of the defined dynamic location region of the vehicle component from a capture region of the environment capturing sensor system. The method further comprises outputting a control signal for capturing the vehicle environment in the defined restricted capture region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a vehicle with a control device in a plan view;

FIG. 2a schematically shows the vehicle with a dynamic location region of the wheels of the vehicle;

FIG. 2b shows a representation of a functional relationship between a steering angle and a dynamic transverse extent component of the location region of the wheels;

FIG. 3a schematically shows the vehicle with a further dynamic location region of the wheels of the vehicle;

FIG. 3b shows representations of functional relationships between the steering angle and a dynamic longitudinal extent component of the location region of the wheels; and

FIG. 4 shows a flow diagram of steps of a method for carrying out a method for controlling an environment capturing sensor system of the vehicle according to an embodiment of the present disclosure.

### DETAILED DESCRIPTION

The present disclosure relates in an aspect to a method for controlling an environment capturing sensor system. The environment capturing sensor system can have at least one sensor for capturing the environment of a vehicle. The sensor can be a radar device or a laser scanner, for example. The environment capturing sensor system is arranged on a vehicle. The environment capturing sensor system can be fixed on the vehicle. The environment capturing sensor system can be fixedly arranged in a coordinate system bound to the vehicle. The vehicle can be a motor vehicle or a commercial vehicle.

The method has as a single step reading out a control signal for controlling a vehicle component of the vehicle. The vehicle component can be controlled by a control unit, which can be arranged on the vehicle. The vehicle component can be controlled in such a way that the position of the vehicle component relative to the environment capturing sensor system changes. The vehicle component can be controlled in such a way that the position of the vehicle component relative to the environment capturing sensor system changes during an operation or while the vehicle is being driven. The environment capturing sensor system can be movably arranged on the vehicle.

As a further step, the method involves defining a dynamic region of the vehicle component within an outer contour of the vehicle depending on the control signal read out. The vehicle component can be controlled in such a way that the position of the vehicle component relative to the environment capturing sensor system within the outer contour of the vehicle changes. The vehicle component can therefore be a dynamic vehicle component in the coordinate system bound to the vehicle. The dynamic location region of the vehicle component can be a current location region of the vehicle component, which changes in its relative position to the environment capturing sensor system. The dynamic location region can therefore also be a changing location region relative to the environment capturing sensor system.

The vehicle component can be a component of the vehicle that can already be installed on the vehicle at the factory. The vehicle component can be arranged within the outer contour of the vehicle. An outer contour of the vehicle component can therefore be a part of the outer contour of the vehicle. The outer contour of the vehicle can therefore include the outer contour of the vehicle component. Furthermore, the outer contour of the vehicle can change depending on the changing position of the vehicle component relative to the environment capturing sensor system.

As a further step, the method involves defining a restricted capture region by omitting at least a sub region of the defined dynamic location region of the vehicle component from the capture region of the environment capturing sensor system. The restricted capture region therefore does not have the sub region of the defined dynamic location region. The defined restricted capture region can thus be defined depending on the defined dynamic location region of the vehicle component. Furthermore, the restricted capture region does not include the outer contour of the vehicle.

As a further step, the method involves outputting a control signal to capture the surroundings of the vehicle in the defined restricted capture region. The control signal can be output to the environment capturing sensor system. Alternatively or additionally, the control signal can be output to a control unit of the environment capturing sensor system. The control signal can be designed in such a way that the vehicle environment is not detected by the environment capturing sensor system in the sub region of the defined dynamic location region of the vehicle component. The control signal can be designed in such a way that measurement data from the environment capturing sensor system, which captures the vehicle environment in the sub region of the defined dynamic location region of the vehicle component, are filtered.

According to embodiments of the present disclosure, a capture region of an environment capturing sensor system can thus be adapted to a dynamically changing outer contour of the vehicle. The effective capture region of the environment capturing sensor system can be increased with embodiments of the present disclosure, as only a current dynamic location region of the vehicle component can be omitted. Since this only takes into account a current location region of a moving vehicle component, regions in which the vehicle component is not currently located can be included in the capture region. Embodiments of the present disclosure can therefore be used to define an adaptive capture region, which can adapt to the dynamic location region of the vehicle component.

According to an embodiment of the method, a static location region of vehicle components of the vehicle can be predetermined. The static location region can be a region spanned by the outer contour of vehicle components, wherein these vehicle components are fixedly arranged on the vehicle. The vehicle components that are fixedly arranged on the vehicle can have a fixed position relative to the environment capturing sensor system within the outer contour of the vehicle. The vehicle components that are fixedly attached to the vehicle can therefore be a static vehicle component in the coordinate system bound to the vehicle. The static location region can therefore also be a location region that does not change relative to the environment capturing sensor system. The static location region can also be extended by a static buffer region around the outer contour.

According to an embodiment, in the step of defining the restricted capture region, the restricted capture region can be implemented by omitting at least one sub region of the predetermined static location region and at least one sub region of the defined dynamic location region from the capture region of the environment capturing sensor system. Here at least one sub region of the defined dynamic location region can be omitted from the predetermined static location region.

According to an embodiment of the method, the control signal read out in the readout step can have data relating to a relative position parameter of the vehicle component in relation to the environment capturing sensor system. The relative position parameter can be characterized by at least one position parameter of the vehicle component in the coordinate system bound to the vehicle. The relative position parameter can be characterized by a relative orientation of the vehicle component in relation to the environment capturing sensor system. The relative position parameter can be characterized by an orientation of the vehicle component in the coordinate system bound to the vehicle. Alternatively or in addition to the relative orientation, the relative position parameter of the vehicle component can be characterized by a relative position of the vehicle component in relation to the environment capturing sensor system. The relative position parameter can be characterized by a position of the environment capturing sensor system in the vehicle coordinate system.

The dynamic location region of the vehicle component can be defined depending on the data relating to the relative position parameter of the vehicle component within the outer contour of the vehicle. The dynamic location region of the vehicle component can thus be determined according to the present disclosure without capture by sensor of the position of the vehicle component. When capturing objects in the vicinity of the vehicle, it can thus be efficiently avoided that a vehicle component itself is mistakenly captured as an object in the vehicle environment.

In principle, the vehicle component can be any vehicle component of the vehicle that forms the outer contour of the vehicle and can be controlled in such a way that its position can be changed relative to the environment capturing sensor system. The vehicle component can therefore be a vehicle component arranged on a vehicle body of the vehicle so as to protrude from it. For example, the vehicle component can be a vehicle door or a tool attached to the vehicle or an add-on device.

According to an embodiment of the method, the vehicle component can be a wheel of the vehicle. When the vehicle is cornering, the wheel of the vehicle can be controlled in such a way that the wheel swings out of a wheel arch of the vehicle. The wheel can swing into the capture region of the environment capturing sensor system. The dynamic location region can therefore be a dynamic swivel region of the wheel.

According to the preceding embodiment, the control signal read out in the readout step can have data relating to a steering angle for the deflection of the wheel. In the step of defining the dynamic location region, the dynamic location region of the wheel can be determined depending on the steering angle for deflection of the wheel. A safety-relevant side region of the vehicle in the vicinity of a wheel during operation of the vehicle can thus be captured so precisely that only a current deflection region of the wheel is omitted from the capture region.

According to an embodiment of the method, it can have as a further step a determination of a dynamic extent of the dynamic location region along the transverse axis of the vehicle depending on the control signal read out. The dynamic extent can be a transverse extent of the dynamic location region. According to this embodiment, the step of defining the dynamic location region can be carried out based on the specific dynamic extent of the dynamic location region along the transverse axis of the vehicle. Thus, a dynamic location region of the vehicle component in a side region of the vehicle can be precisely and efficiently adapted to dynamic vehicle components in the side region.

According to an embodiment of the method, it can have as a further step a determination of a dynamic extent of the dynamic location region along the vehicle longitudinal axis depending on the control signal read out. The dynamic extent can be a longitudinal extent of the dynamic location region. According to this embodiment, the step of defining the dynamic location region can be carried out based on the specific dynamic extent of the dynamic location region along the vehicle longitudinal axis. The longitudinal extent can also be a corresponding dynamic extent of the dynamic location region in a side region of the vehicle. The capture region in the side region of the vehicle can thus be adapted even more efficiently to the dynamic location region of dynamic vehicle components in the side region.

According to an embodiment of the method, the step of defining the dynamic location region can be carried out on the basis of a predetermined functional relationship between the control signal read out and at least one dynamic spatial dimension of the dynamic location region. The dynamic spatial dimension can be a dynamic transverse extent component, which can be predetermined along the transverse vehicle axis. The dynamic spatial dimension can be a dynamic longitudinal extent component as an alternative or in addition to the dynamic transverse extent component, which can be predetermined along the longitudinal vehicle axis. If the vehicle component is the wheel of the vehicle, the functional relationship between the data relating to the steering angle or the steering angle itself and the at least one dynamic spatial dimension can be predetermined. The capture region can thus be adapted to the dynamic location region of the vehicle component on the control side and without capture by sensor of the vehicle component.

The present disclosure relates in a further aspect to a control device for controlling an environment capturing sensor system. The environment capturing sensor system is arranged on the vehicle. The control device can be set up to carry out the method in accordance with the preceding aspect. The control device can have at least one unit that can be set up to carry out at least one of the steps described for the method according to the preceding aspect.

The control device is set up to read out a control signal for controlling a vehicle component of the vehicle. The vehicle component can be controlled in such a way that the position of the vehicle component relative to the environment capturing sensor system changes. The control device is also set up to define a dynamic location region of the vehicle component within an outer contour of the vehicle depending on the control signal read out. The control unit is also set up to define a restricted capture region by omitting at least a sub region of the defined dynamic location region of the vehicle component from the capture region of the environment capturing sensor system. The control device is also set up to output a control signal to capture the vehicle environment in the defined restricted capture region.

In a further aspect, the present disclosure relates to a vehicle which has an environment capturing sensor system. The environment capturing sensor system is arranged on the vehicle for capturing a vehicle environment. The vehicle has the control device according to the previous aspect, which can be set up to control the environment capturing sensor system.

Embodiments of an aspect of the present disclosure can form corresponding embodiments of any other aspect of the present disclosure.

### Detailed Description of Embodiments

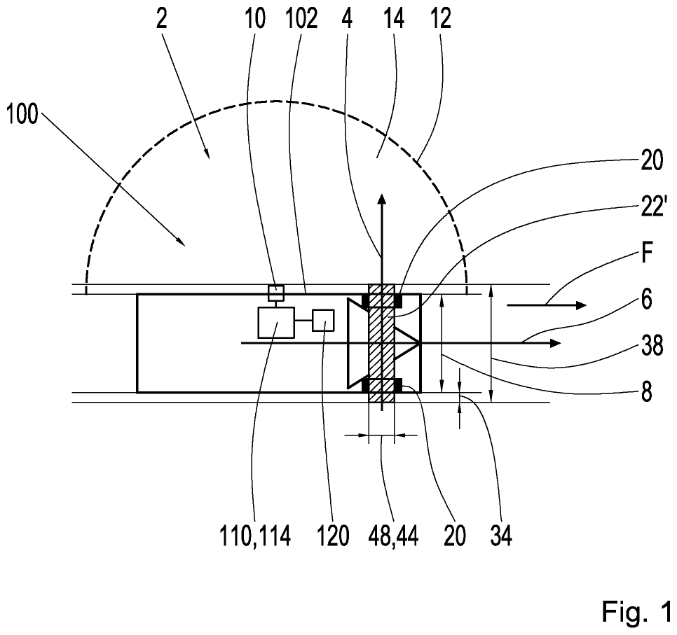

FIG. 1 shows a vehicle 100 on which an environment capturing sensor system 10 is arranged. The environment capturing sensor system 10 is fixedly arranged on a side region of an outer contour 102 of the vehicle 100. The environment capturing sensor system 10 has a capture region 12 in which objects of the vehicle 100 located in a vehicle environment 2 can be captured with the environment capturing sensor system 10.

The vehicle 100 has vehicle components 20 which are steerable wheels 21 of the vehicle according to an embodiment. The vehicle 100 has the steerable wheels 21, wherein the wheels 21 in the embodiment shown are front wheels of the vehicle 100. The outer contour 102 also spans the wheels 21 of the vehicle 100. The vehicle 100 has undeflected wheels 21 in the operating state of the vehicle 100 shown in FIG. 1. In the undeflected state of the wheels 21, a static location region 22′ is defined, which extends along a transverse vehicle axis 4 and a longitudinal vehicle axis 6 of the vehicle 100. The static location region 22′ extends along the transverse vehicle axis 4 along the transverse extent of the vehicle and a respective static transverse extent component 34, which in the direction of travel F of the vehicle 100 extends the transverse extent of the vehicle 8 to the outside to the left and right. In the state with undeflected wheels 21, a transverse extent 38 of the static location region 22′ thus corresponds to the sum of the transverse vehicle extent 8 and twice the static transverse extent component 34. A longitudinal extent 48 of the static location region 22′ is defined along a longitudinal vehicle axis 6 of the vehicle 100. The longitudinal extent 48 has a static longitudinal extent component 44, which corresponds to the radius of a wheel 21 according to an embodiment.

The vehicle 100 has a control device 110 which controls the environment capturing sensor system 10 for capturing an object in the capture region 12. The static location region 22′, which is formed on the basis of the static transverse extent component 34 and the static longitudinal extent component 44, is omitted from the capture region 12, whereby a restricted capture region 14 is formed. The control device 110 controls the environment capturing sensor system 10 in such a way that an object is only captured in the restricted capture region 14.

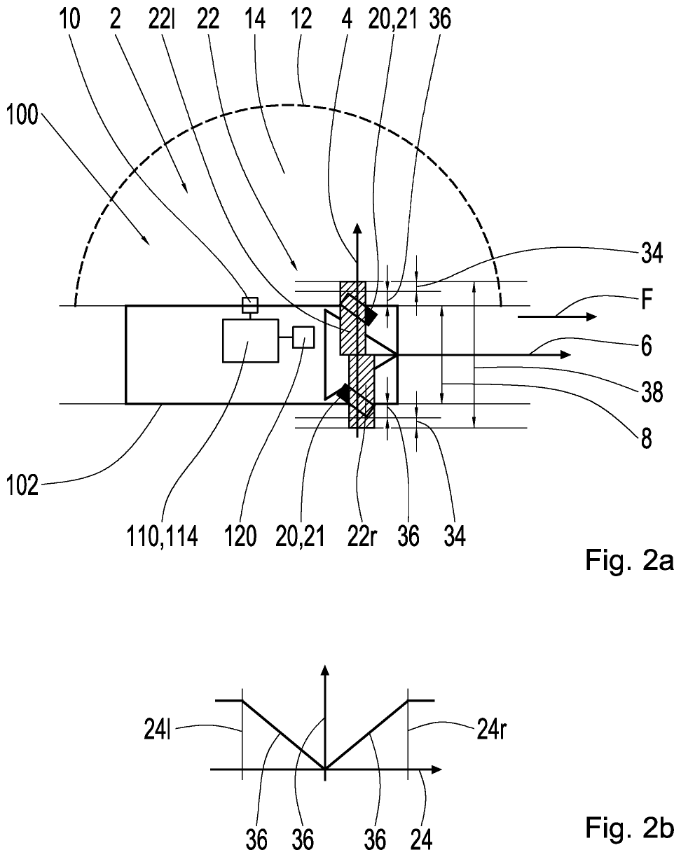

FIG. 2a shows the vehicle 100 in another operating state, in which the wheels 21 are deflected to the right in the direction of travel F of the vehicle 100. As a dynamic location region 22, the location region has a left-hand location region 22l and a right-hand location region 22r. The dynamic location region 22 is extended to the left and right in the direction of travel F of the vehicle 100 with a dynamic transverse extent component 36.

The dynamic transverse extent component 36, as shown in FIG. 2b, is formed by a functional relationship between a steering angle 24 and the dynamic transverse extent component 36. The dynamic transverse extent component 36 increases linearly to deflect the wheels 21 to the right and left up to a maximum steering angle 24r, 24l. The transverse extent 38 of the dynamic location region 22 is formed along the transverse vehicle axis 4 from the sum of the transverse vehicle extent 8, twice the dynamic transverse extent component 36 and twice the static transverse extent component 34. Compared to the static location region 22′ in the undeflected wheels 21 state shown in FIG. 1, the dynamic location region 22 is thus symmetrically extended to the left and right in the direction of travel F of the vehicle 100 by the dynamic transverse extent component 36.

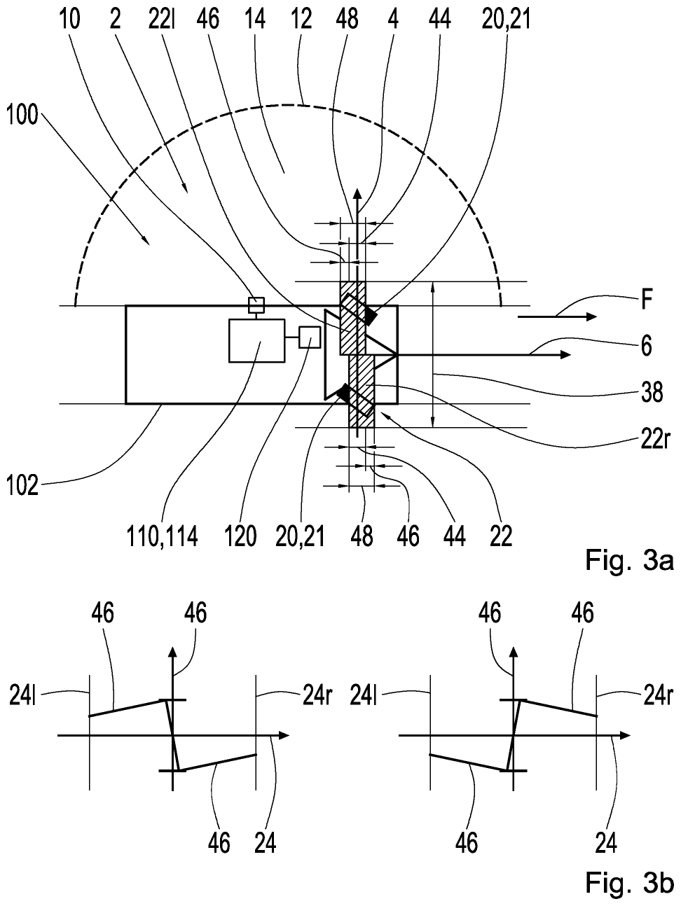

FIG. 3a shows the deflected state of the wheels 21 shown in FIG. 2a. The longitudinal extent 48 of the dynamic location region 22 is extended compared to the static location region 22′ in the undeflected state of the wheels 21 shown in FIG. 1. The left location region 22l is extended rearwards in the right deflected state of the wheels 21 in the direction of travel F of the vehicle 100 shown in FIG. 3a and the right location region 22r is extended forwards in this state. The longitudinal extent 48 has the static longitudinal extent component 44 and a dynamic longitudinal extent component 46, which extends the left location region 22l rearwards and the right location region 22r forwards.

In FIG. 3b on the left, functional relationships between the steering angle 24 and the dynamic longitudinal extent component 46 for the left location region 22l are shown. Starting from an undeflected state, the static longitudinal extent component 44 is extended rearwards by a negative proportion of the dynamic longitudinal extent component 46 for the right-deflected state of the wheels 21 shown in FIG. 2a. If the wheels 21 are deflected to the left, the static longitudinal extent component 44 is extended forwards by a positive proportion of the dynamic longitudinal extent component 46. The functional relationship is applied linearly up to the respective maximum steering angles 24r, 24l.

With the opposite sign, for the right location region 22r, as shown in FIG. 3b on the right, the static longitudinal extent component 44 for the right deflected state of the wheels 21 shown in FIG. 2a is extended by a positive proportion of the dynamic longitudinal extent component 46. If the wheels 21 are deflected to the left, the static longitudinal extent component 44 is extended rearwards by a negative proportion of the dynamic longitudinal extent component 46. The static longitudinal extent component 44 is thus asymmetrically extended by the dynamic longitudinal extent component 46 for the left and right location regions 22l , 22r of the dynamic location region 22 when the wheels 21 are deflected to the right and left.

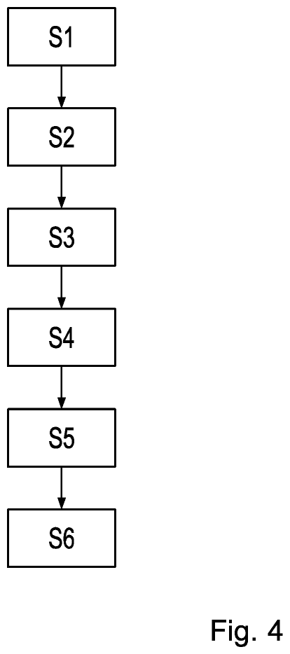

FIG. 4 shows steps S1 to S6 for carrying out a method for controlling the environment capturing sensor system 10 of the vehicle 100 in a chronological sequence. In a first step S1, a control signal is read out from a control unit 120 for controlling the wheels 21 of the vehicle 100. The wheels 21 are controlled by the control unit 120 in such a way that the position of the wheels 21 relative to the environment capturing sensor system 10 as described for FIGS. 2a and 3a changes. In the step S1, data relating to the steering angle 24 of the wheels 21 is read out from the control unit 120.

In a further step S2 of the method, the dynamic location region 22 within the outer contour 102 of the vehicle 100 depending on the data read out relating to the steering angle 24, as shown in FIGS. 2b and 3b, is defined by a functional relationship between the steering angle 24 and the dynamic transverse extent component 36 and the dynamic longitudinal extent component 46 of the dynamic location region 22. In a first sub step, the dynamic transverse extent component 36 is determined. In a further sub step, the dynamic longitudinal extent component 46 is determined.

In a further step S3 of the method, the sub region of the defined dynamic location region 22, which overlays the capture region 12 of the environment capturing sensor system 10 in some areas, is omitted from the capture region 12 in order to define the restricted capture region 14 in a further step S4 of the method.

In a further step S5 of the method, a control signal is output by control device 110 to the environment capturing sensor system 10 in order to capture the vehicle environment 2 only in the defined restricted capture region 14. In a further step S6 of the method, objects in the vehicle environment 2 are only captured in the restricted capture region 14. Steps S1 to S6 are carried out by an evaluation unit 114 of the control device 110.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

2 Vehicle environment
4 Transverse vehicle axis
6 Longitudinal vehicle axis
8 Transverse vehicle extent
10 Environment capturing sensor system
12 Capture region
14 Restricted capture region
20 Vehicle components
21 Wheel
22 Dynamic location region
22 Static location region
22l Left location region
22r Right location region
24 Steering angle
24L, 24R Maximum steering angle
34 Static transverse extent component
36 Dynamic transverse extent component
38 Transverse extent
44 Static longitudinal extent component
46 Dynamic longitudinal extent component
48 Longitudinal extent
100 Vehicle
102 Outer contour
110 Control device
114 Evaluation unit
120 Control unit
F Direction of travel
S1 Readout control signal
S2 Define location region
S3 Omit location region
S4 Capture vehicle environment
S5 Output control signal
S6 Capture vehicle environment

1. A method for controlling an environment capturing sensor system which is arranged on a vehicle, comprising:
reading a control signal for controlling a vehicle component of the vehicle, wherein the vehicle is configured to be controlled suchthat the position of the vehicle component relative to the environment capturing sensor system changes;
defining a dynamic location region of the vehicle component within an outer contour of the vehicle depending on the read control signal;
defining a restricted capture region by omitting at least a sub region of the defined dynamic location region of the vehicle component from a capture region of the environment capturing sensor system; and
outputting a control signal for capturing the vehicle environment in the defined restricted capture region.

2. The method as claimed in claim 1, wherein the read control signal p has data relating to a relative position parameter of the vehicle component with respect to the environment capturing sensor system.

3. The method as claimed in claim 1, wherein the vehicle component has a wheel of the vehicle and the read control signal has data relating to a steering angle for deflecting the wheel.

4. The method as claimed in claim 1, comprising determining a dynamic extent of the dynamic location region along a transverse vehicle axis depending on the readout control signal, wherein the defining of the dynamic location region is carried out based on the determined dynamic extent.

5. The method as claimed in claim 1, comprising determining a dynamic extent of the dynamic location region along a longitudinal vehicle axis depending on the read control signal, wherein the defining of the dynamic location region is carried out based on the determined dynamic extent.

6. The method as claimed in claim 1, wherein the defining of the dynamic location region is carried out based on a predetermined functional relationship between the read control signal and at least one dynamic spatial dimension of the dynamic location region.

7. A control device for controlling an environment capturing sensor system which is arranged on a vehicle, the control device being configured to;
read out a control signal for controlling a vehicle component of the vehicle, wherein the vehicle is configured to be controlled such that a position of the vehicle component relative to the environment capturing sensor system changes,
define a dynamic location region of the vehicle component within an outer contour of the vehicle depending on the control signal read out,
define a restricted capture region by omitting at least a sub region of the defined dynamic location region of the vehicle component from a capture region of the environment capturing sensor system, and
output a control signal to capture the vehicle environment in the defined restricted capture region.

8. A vehicle, comprising:
an environment capturing sensor system arranged on the vehicle and configured to capture a vehicle environment; and
the control device as claimed in claim 7.
